(19) United States
(12) Patent Application Publication
(10) Pub. No.: US 2009/0091258 A1
(43) Pub. Date: Apr. 9, 2009

(54) Optoelectronic Component and Method for Producing an Optoelectronic Component

(75) Inventors: Karsten Heuser, Erlangen (DE); Norwin von Malm, Nittendorf (DE)

Correspondence Address: COHEN, PONTANI, LIEBERMAN & PAVANE LLP, 551 FIFTH AVENUE, SUITE 1210, NEW YORK, NY, 10176, US

(73) Assignee: OSRAM Opto Semiconductors Gmbh, Regensburg (DE)

(21) Appl. No.: 12/235,121

(22) Filed: Sep. 22, 2008

(30) Foreign Application Priority Data
Sep. 20, 2007 (DE) 10 2007 044 865.3
Oct. 31, 2007 (DE) 10 2007 052 181.4

(51) Int. Cl. H01J 1/70; H01J 9/12

(52) U.S. Cl. 313/512; 445/51

(57) ABSTRACT

An optoelectronic comprises a substrate (1), a first electrode (2) on the substrate (1), a radiation-emitting layer sequence (3) having an active region (30) that emits an electromagnetic primary radiation during operation, a second electrode, which is transparent to the primary radiation, on the radiation-emitting layer sequence (3), and an encapsulation arrangement (10) deposited on the second electrode (4). The encapsulation arrangement (10) has a layer stack having at least one first barrier layer (6) and at least one first wavelength conversion layer (5) that converts the primary radiation at least partly into electromagnetic secondary radiation. The encapsulation arrangement (10) is at least partly transparent to the primary radiation and/or to the secondary radiation.

### RELATED APPLICATION

This patent application claims the priorities of German patent application 10 2007 044 865.3 filed Sep. 20, 2007 and of German patent application 10 2007 052 181.4 filed Oct. 31, 2007, the disclosure contents of both of which are hereby incorporated by reference.

### FIELD OF THE INVENTION

The present invention is related to an optoelectronic component having a radiation-emitting layer sequence and to a method for producing an optoelectronic component.

### BACKGROUND OF THE INVENTION

Optoelectronic components having radiation-emitting layer sequences can emit electromagnetic radiation which can give an observer a color impression. Thereby, it may be desirable for said color impression of the radiation-emitting layer sequence to be modified at least partly by means of luminescence converters.

### SUMMARY OF THE INVENTION

One object of specific embodiments of the present invention is to provide an optoelectronic component having a radiation-emitting layer sequence which has a wavelength conversion layer. Furthermore, it is an object of specific embodiments of the present invention to provide a method for producing an optoelectronic component.

An optoelectronic component in accordance with one embodiment comprises in particular

a substrate,

a first electrode on the substrate,

a radiation-emitting layer sequence having an active region that emits an electromagnetic primary radiation during operation,

on the radiation-emitting layer sequence a second electrode which is transparent to the primary radiation, and

an encapsulation arrangement deposited on the second electrode,

wherein

the encapsulation arrangement has a layer stack having at least one first barrier layer and at least one first wavelength conversion layer that converts the primary radiation at least partly into electromagnetic secondary radiation,

the encapsulation arrangement is at least partly transparent to the primary radiation and/or to the secondary radiation.

The fact that one layer or one element is arranged or applied “on” or “above” another layer or another element can mean here and hereinafter that said one layer or one element is arranged directly in direct mechanical and/or electrical contact on the other layer or the other element. Furthermore, it can also mean that said one layer or one element is arranged indirectly on or respectively above the other layer or the other element. In this case, further layers and/or elements can then be arranged between said one and the other layer.

The encapsulation arrangement can be suitable for protecting the electrodes and the radiation-emitting layer sequence against moisture and/or oxidizing substances such as oxygen, for instance. At the same time, the same encapsulation arrangement can afford the possibility of setting the luminous impression that can be given to an observer by the optoelectronic component, by means of a suitable choice and arrangement of the wavelength conversion layer. The combination of the first barrier layer and the first wavelength conversion layer in the encapsulation arrangement can thus enable a compact optoelectronic component which can furthermore be produced by means of a technically simple-to-control and cost-effective production process.

A conventional encapsulation in the form of a volume potting or a cover can thus be unnecessary. Thereby, the use of a wavelength conversion layer in the encapsulation arrangement can be advantageous in order to avoid a differential color ageing, for example, which can occur when a plurality of different active regions are used for generating mixed light. On the other hand, the color locus of the luminous impression of the optoelectronic component can be optimized independently of the electronic properties of the radiation-emitting layer sequence.

In particular, the optoelectronic component can emit a superposition of the primary radiation and the secondary radiation. In this case, part of the primary radiation can pass through the wavelength conversion layer and also the first barrier layer without being converted and can emerge from the encapsulation arrangement. Furthermore, the electromagnetic secondary radiation can also emerge from the encapsulation arrangement and be emitted from the latter. For an external observer, therefore, a mixed-colored luminous impression can be perceived as a result of the superposition of the electromagnetic primary radiation and electromagnetic secondary radiation. In this case, the mixed-colored luminous impression can depend on the relative proportions of the primary radiation and secondary radiation with respect to one another. The primary radiation and the secondary radiation can have mutually different wavelength ranges. As a result, it is possible to produce a mixture of, for example, different colors of the electromagnetic radiation which lead to an overall radiation having the desired resultant color.

The first barrier layer can comprise a material suitable for protecting the electrodes and the organic semiconductor layer sequence against damaging influences of the surroundings, that is to say for instance against oxygen and/or moisture. In particular, the barrier layer can be impermeable or permeable only with difficulty for oxygen and/or moisture. By way of example, the barrier layer can comprise an oxide, a nitride or an oxynitride. By way of example, the oxide, nitride or oxynitride can furthermore comprise aluminum, silicon, tin or zinc. In this case, the barrier layer can have dielectric or else electrically conductive properties and comprise for example silicon oxide, for instance SiO₂, silicon nitride, for instance Si₂N₃, silicon oxynitride (SiOₓN_{y}), aluminum oxide, for instance Al₂O₃, aluminum nitride, tin oxide, indium tin oxide, zinc oxide or aluminum zinc oxide. As an alternative or in addition, the barrier layer can comprise a material suitable for binding oxygen and/or moisture and thereby preventing said oxygen and/or moisture from penetrating through the barrier layer. Suitable materials for this can be alkali and alkaline earth metals, for example.

The first barrier layer can be producible for example by means of an application method such as a vapor deposition method or deposition method, for instance. Such an application method can be a method for chemical vapor deposition (CVD) or a method for physical vapor deposition (PVD) or a combination of such methods. As examples of such application methods mention may be made of thermal evaporation, electron beam evaporation, laser beam evaporation, arc evaporation, molecular beam epitaxy, sputtering, ion plating and plasma enhanced chemical vapor deposition.

Furthermore, the first wavelength conversion layer can comprise one or a plurality of wavelength conversion substances suitable for at least partly absorbing the electromagnetic primary radiation and emitting it as secondary radiation with a wavelength range that differs at least partly from the primary radiation. The electromagnetic primary radiation and electromagnetic secondary radiation can comprise one or a plurality of wavelengths and/or wavelength ranges in an infrared to ultraviolet wavelength range, in particular in a visible wavelength range. In this case, the spectrum of the primary radiation and/or the spectrum of the secondary radiation can be narrowband, that is to say that the primary radiation and/or the secondary radiation can have a single-colored or approximately single-colored wavelength range. As an alternative, the spectrum of the primary radiation and/or the spectrum of the secondary radiation can also be broadband, that is to say that the primary radiation and/or the secondary radiation can have a mixed-colored wavelength range, wherein the mixed-colored wavelength range can have a continuous spectrum or a plurality of discrete spectral components having different wavelengths. By way of example, the electromagnetic primary radiation can have a wavelength range from an ultraviolet to green wavelength range, while the electromagnetic secondary radiation can have a wavelength range from a blue to infrared wavelength range. Particularly preferably, the primary radiation and the secondary radiation superposed can give a white-colored luminous impression. For this purpose, the primary radiation can preferably give a blue-colored luminous impression and the secondary radiation a yellow-colored luminous impression, which can arise as a result of spectral components of the secondary radiation in the yellow wavelength range and/or spectral components in the green and red wavelength range.

Thereby, the wavelength conversion substance can comprise one or a plurality of the following materials: garnets of the rare earths and the alkaline earth metals, for example YAG:Ce³⁺, nitrides, nitridosilicates, siones, sialones, aluminates, oxides, halophosphates, orthosilicates, sulfides, vanadates and chlorosilicates. Furthermore, the wavelength conversion substance can additionally or alternatively comprise an organic material which can be selected from a group comprising perylenes, benzopyrenes, coumarins, rhodamins, and azo dyes. Further examples and embodiments are described in the patent application DE 102007049055.6, the disclosure content of which is hereby incorporated by reference. The wavelength conversion layer can comprise suitable mixtures and/or combinations of the wavelength conversion substances mentioned. As a result, it can be possible, for example, that, as described above, the wavelength conversion layer absorbs in a blue first wavelength range and emits in a second wavelength range having green and red wavelengths and/or yellow wavelength ranges.

Furthermore, the wavelength conversion layer can comprise a transparent matrix material which surrounds or contains the wavelength conversion substance or substances which is chemically bonded to the wavelength conversion substance or substances. The transparent matrix material can comprise for example siloxanes, epoxides, acrylates, methyl methacrylates, imides, carbonates, olefins, styrenes, urethanes or derivatives thereof in the form of monomers, oligomers or polymers and furthermore also mixtures, copolymers or compounds therewith. By way of example, the matrix material can comprise or be an epoxy resin, polymethyl methacrylate (PMMA), polystyrene, polycarbonate, polyacrylic, polyurethane or a silicone resin such as, for instance, polysiloxane or mixtures thereof.

Thereby, the wavelength conversion substance or substances can be distributed homogeneously in the matrix material. Furthermore, the wavelength conversion layer can comprise a plurality of wavelength conversion substances which are arranged in different layers in the wavelength conversion layer. In particular, the wavelength conversion substance or substances can be contained in the matrix material which can be present in a liquid phase before the application of the wavelength conversion layer. The liquid matrix material with the wavelength conversion substance or substances can then be applied above the second electrode and be formed in layered fashion as a wavelength conversion layer by means of drying and/or crosslinking processes. As an alternative, the matrix material with the wavelength conversion substance can also be applied by vapor deposition. Furthermore, the matrix material with the wavelength conversion substance can then be cured by crosslinking reactions.

The wavelength conversion substance or substances can be shaped in the form of particles that can have a size of 2 to 10 μm. Furthermore, the particles can at least partly scatter the primary radiation and/or the secondary radiation. Thus, a wavelength conversion substance can simultaneously be formed as a luminous centre that partly absorbs radiation of the primary radiation and emits a secondary radiation, and as a scattering centre for the primary radiation and/or the secondary radiation. Such scattering properties of a wavelength conversion substance can thus lead to an improved coupling out of radiation. The scattering effect can for example also lead to an increase in the probability of absorption of primary radiation in the wavelength conversion layer, whereby a smaller layer thickness of the wavelength conversion layer can be necessary.

The encapsulation arrangement can be applied on the second electrode in such a way that the first barrier layer is arranged on the second electrode and the first wavelength conversion layer is arranged on the first barrier layer. Furthermore, in this case, a planarization layer, for example composed of a material as mentioned above in connection with the matrix material, can be applied before the application of the first barrier layer on the second electrode. A continuous barrier layer on the second electrode can be made possible as a result. In this case, the planarization layer can have a thickness that is larger than the unevenness of the underlying layer, for instance of the second electrode.

Furthermore, the first wavelength conversion layer can be applied on the second electrode and the first barrier layer can be applied on the first wavelength conversion layer. As a result, the first wavelength conversion layer can additionally perform the function of the planarization layer mentioned above.

In addition, the encapsulation arrangement can have a second barrier layer. In this case, the second barrier layer can have features as presented above in connection with the first barrier layer. In this case, the second barrier layer can comprise the same material as, or a different material from, the first barrier layer. Furthermore, the second barrier layer can comprise the same material as the first barrier layer, but in this case be constructed with a different microstructure and/or modification. Thus, the first barrier layer can be present as α-aluminum oxide, for example, while the second barrier layer can be present as γ-aluminum oxide. It is thereby possible to avoid the formation of continuous microchannels, so-called “pin holes”, which could continue from one of the barrier layers into the other.

The first wavelength conversion layer can furthermore be arranged between the first and second barrier layers. Such an arrangement can also prevent the formation of continuous “pin holes” in the barrier layers, whereby the permeability of the encapsulation arrangement with respect to oxygen and/or moisture can be reduced.

The encapsulation arrangement can also have a plurality of barrier layers and a plurality of wavelength conversion layers. In this case, “a plurality of layers” here and hereinafter can mean at least two or more layers. In this case, as explained above, the barrier layers of the plurality of barrier layers can comprise identical and different materials and identical or different material modifications or microstructures. Thereby, each of the plurality of barrier layers and of the plurality of wavelength conversion layers can have features mentioned above with regard to the first barrier layer and the first wavelength conversion layer, respectively.

In particular, in the case of the arrangement of a plurality of barrier layers and/or wavelength conversion layers, the individual layers can for example each have a smaller thickness than in the case of only one barrier layer and/or wavelength conversion layer, without the barrier properties and/or wavelength conversion properties, respectively, of the encapsulation arrangement being reduced. The use of a plurality of barrier layers and/or wavelength conversion layers which each have a small thickness makes it possible to improve the optical properties of the encapsulation arrangement such as, for instance, the coupling-out efficiency and a viewing-angle-independent emission of the primary radiation and/or secondary radiation. The smaller the respective thickness of the individual barrier layers and/or wavelength conversion layers, the smaller for example the waveguide properties of the respective individual layers can be. For this purpose, for example at least the first barrier layer or else two or more or all of a plurality of barrier layers can have a thickness which can be less than or equal to a characteristic wavelength of the primary radiation and/or the secondary radiation. Furthermore, the thickness can be less than or equal to half or a quarter of the characteristic wavelength of the primary radiation and/or the secondary radiation. The thickness can furthermore be greater than or equal to a tenth or else greater than or equal to an eighth of the characteristic wavelength of the primary radiation and/or the secondary radiation.

Thereby, the characteristic wavelength can denote the highest-intensity wavelength of the spectrum of the primary radiation and/or the secondary radiation. As an alternative, the characteristic wavelength can also denote the average wavelength of the spectral range in which the primary radiation and/or the secondary radiation lies. Furthermore, the characteristic wavelength can also denote the average wavelength—weighted over the individual spectral intensities—of the spectrum of the primary radiation and/or the secondary radiation. In this sense the primary radiation can have a first characteristic wavelength and the secondary radiation can have a second characteristic wavelength.

Furthermore, the encapsulation arrangement can have a surface structure on a surface remote from the radiation-emitting layer sequence, which surface can be for example a radiation coupling-out area of the optoelectronic component. Such a surface structure can have roughenings, trenches, prisms, lenses or truncated cones or combinations thereof, which can increase and improve for example the radiation coupling-out of the primary radiation and the secondary radiation from the encapsulation arrangement. In this case, the surface structure can be formed in a barrier layer or a wavelength conversion layer, depending on the configuration of the encapsulation arrangement. As an alternative or in addition, the encapsulation arrangement, on the first barrier layer and/or the first wavelength conversion layer, or on the plurality of barrier layers and the plurality of wavelength conversion layers, can have an outer layer, in which the surface structure is formed. The outer layer can comprise for example a material as explained further above in connection with the matrix material, for instance a polymer material.

The encapsulation arrangement can cover the entire radiation-emitting layer sequence with the electrodes. Furthermore, the encapsulation arrangement can cover at least one part of the surface of the substrate on which the radiation-emitting layer sequence with the first and second electrodes are arranged. In addition, the encapsulation arrangement can also surround the entire substrate. As an alternative, the substrate together with the encapsulation arrangement can form an encapsulation for the electrodes and the radiation-emitting layer sequence. In this case, the encapsulation arrangement can have further layers such as, for instance, planarization layers, barrier layers, water and/or oxygen absorbing layers, connecting layers or combinations thereof. As an alternative or in addition, the encapsulation arrangement can have a further layer stack having at least one barrier layer and/or at least one wavelength conversion layer on a surface of the substrate that is remote from the radiation-emitting layer sequence.

By virtue of the fact that the second electrode is transparent to the primary radiation and the encapsulation arrangement is at least partly transparent to the primary radiation and/or the secondary radiation, the optoelectronic component can be embodied as a so-called “top emitter” and emit the primary radiation and/or the secondary radiation from the encapsulation arrangement. As a result, it is possible for example to choose a substrate material independently of its optical properties.

In this case, the substrate can comprise glass, quartz, plastic, polymer films, metal, metal films, silicon wafers or any other suitable substrate material and be embodied in rigid or flexible fashion. In addition, the optoelectronic component can be embodied as a so-called “bottom emitter”, that is to say that the radiation generated in the active region is also emitted through the substrate so that the substrate can be transparent to at least part of the electromagnetic primary radiation generated in the active region. The optoelectronic component can also be embodied as a combination of “bottom emitter” and “top emitter”. In this case, the optoelectronic component in a switched-off state can be at least partly transparent to visible light or at least part thereof.

The optoelectronic component can have a semiconductor layer sequence as the radiation-emitting layer sequence.

Particularly preferably, the optoelectronic component can be embodied as an organic light-emitting diode (OLED). The OLED can have for example the first electrode on the substrate. A functional region having one or a plurality of functional layers composed of organic materials can be applied above the first electrode. In this case, the functional layers can be embodied for example as electron transport layers, electroluminescent layers and/or hole transport layers. A second electrode can be applied above the functional layers. In the functional layers, electromagnetic radiation having an individual wavelength or a range of wavelengths can be generated in the active region by electron and hole injection and recombination. In this case, a single-colored, a multicolored and/or a mixed-colored luminous impression of the primary radiation can be given to a viewer as described above by emission of narrowband or broadband primary radiation.

The functional layers can comprise organic polymers, organic oligomers, organic monomers, organic small, non-polymeric molecules (“small molecules”), or combinations thereof. Suitable materials and arrangements and patterns of the materials for functional layers are known to the person skilled in the art and are therefore not explained any further at this point.

In particular, the first electrode and/or the second electrode can particularly preferably be embodied areally or alternatively in a manner structured into first and/or second electrode partial regions. By way of example, the first electrode can be embodied in the form of first electrode strips arranged parallel alongside one another and the second electrode can be embodied as second electrode strips arranged parallel alongside one another and running perpendicular to said first electrode strips. Overlapping regions of the first and second electrode strips can thus be embodied as separately drivable luminous regions. Furthermore, it is also possible for only the first or only the second electrode to be structured. Particularly preferably, the first and/or the second electrode or electrode partial regions are electrically conductively connected to first conductor leads. In this case, an electrode or an electrode partial region can merge for example into a first conductor lead or be embodied separately from the first conductor lead and be electrically conductively connected thereto.

The first electrode, which for example can be embodied as an anode and can thus serve as a hole-injecting material, can for example comprise a transparent electrically conductive oxide or consist of a transparent conductive oxide. Transparent electrically conductive oxides (transparent conductive oxides, “TCO” for short), are transparent conductive materials, generally metal oxides, such as, for example zinc oxide, tin oxide, cadmium oxide, titanium oxide, indium oxide, or particularly preferably indium tin oxide (ITO). In addition to binary metal-oxygen compounds, such as, for example, ZnO, SnO₂ or In₂O₃, ternary metal-oxygen compounds, such as, for example, Zn₂SnO₄, CdSnO₃, ZnSnO₃, MgIn₂O₄, GaInO₃, Zn₂In₂O₃ or In₄Sn₃O₁₂ or mixtures of different transparent electrically conductive oxides also belong to the group of TCOs. Furthermore, the TCOs need not necessarily correspond to a stoichiometric composition and can also be p- or n-doped. In this case, the first electrode can preferably be arranged on the substrate and for example also comprise metals and/or metal alloys and/or layer sequences or be composed of those which comprise at least one of the materials Ag, Al, Cr, Mo and Au.

The second electrode can be embodied as a cathode and thus serve as an electron-injecting material. Inter alia, in particular aluminum, barium, indium, silver, gold, magnesium, calcium or lithium and compounds, combinations and alloys thereof can prove to be advantageous as cathode material. In this case, the second electrode can have a thickness of greater than or equal to 1 nm and less than or equal to 50 nm, in particular greater than or equal to 10 nm and less than or equal to 30 nm, and thus be transparent to the primary radiation.

Furthermore, the second electrode can also comprise or be composed of one of the TCOs mentioned above. It is possible for the second electrode to be able to be applied for example by means of one of the CVD and/or PVD methods mentioned further above in connection with the first barrier layer.

As an alternative, the first electrode can be embodied as a cathode and the second electrode as an anode with the abovementioned materials or combinations thereof. Furthermore, the electrodes can also comprise electrically conductive or semiconducting organic material.

Furthermore, the radiation-emitting layer sequence can also be embodied as an epitaxial layer sequence, that is to say as an epitaxially grown inorganic semiconductor layer sequence. In this case, the semiconductor layer sequence can be embodied for example on the basis of an inorganic material, for instance InGaAlN, such as for instance as a GaN thin-film semiconductor layer sequence. InGaAlN-based semiconductor layer sequences include in particular those in which the epitaxially produced semiconductor layer sequence, which generally has a layer sequence composed of different individual layers, contains at least one individual layer which comprises a material from the III-V compound semiconductor material system InₓAl_{y}Ga_{1-x-y}N where 0≦x≦1, 0≦y≦1 and x+y≦1.

As an alternative or in addition, the semiconductor layer sequence can also be based on InGaAlP, that is to say that the semiconductor layer sequence has different individual layers, of which at least one individual layer comprises a material from the III-V compound semiconductor material system InₓAl_{y}Ga_{1-x-y}P where 0≦x≦1, 0≦y≦1 and x+y≦1. As an alternative or in addition, the semiconductor layer sequence can also comprise other III-V compound semiconductor material systems, for example an AlGaAs-based material, or II-VI compound semiconductor material systems.

A method for producing an optoelectronic component in accordance with at least one further embodiment comprises in particular the following steps:

A) providing a substrate with a first electrode, a radiation-emitting layer sequence on the first electrode and a second electrode on the radiation-emitting layer sequence, and

B) applying an encapsulation arrangement having a layer stack comprising at least one first barrier layer and at least one first wavelength conversion layer.

In this case, the optoelectronic component can have one or more of the features mentioned above.

Furthermore, in this case, in step B, the at least one first barrier layer can be applied by means of a vapor deposition method or a growth method as described further above.

In particular, the method can comprise in step B the substeps of

B1) applying the first barrier layer on the second electrode, and

B2) applying the first wavelength conversion layer on the first barrier layer.

As an alternative, the method can comprise in step B the substeps of

B1′) applying the wavelength conversion layer on the second electrode, and

B2′) applying the first barrier layer on the wavelength conversion layer.

In a further substep B3, a second barrier layer can be applied on the first barrier layer and the first wavelength conversion layer.

Furthermore, in step B, a plurality of barrier layers and a plurality of wavelength conversion layers can be applied alternately.

In a further method step C, as described above, a surface structure can be applied on that surface of the encapsulation arrangement which is removed from the radiation-emitting layer sequence. In this case, in step C, the surface structure can be applied by embossing, etching, roughening or laser removal or a combination thereof.

Further advantages and advantageous embodiments and developments of the invention will become apparent from the embodiments described below in conjunction with FIGS. 1A to 6E.

### BRIEF DESCRIPTION OF THE DRAWINGS

FIGS. 1A to 1C show schematic illustrations of a method for producing an optoelectronic component in accordance with one exemplary embodiment, and

FIGS. 2 to 7 show a schematic illustration of optoelectronic components in accordance with further exemplary embodiments.

### DETAILED DESCRIPTION OF THE DRAWINGS

In the exemplary embodiments and figures, identical or identically acting constituent parts may be provided in each case with the same reference symbols. The elements illustrated and their solid relationships among one another should not in principle be regarded as true to scale, but rather individual elements such as, for example, layers, structural parts, components and regions may be illustrated with exaggerated thickness or size dimensions for the sake of better representability and/or for the sake of better understanding.

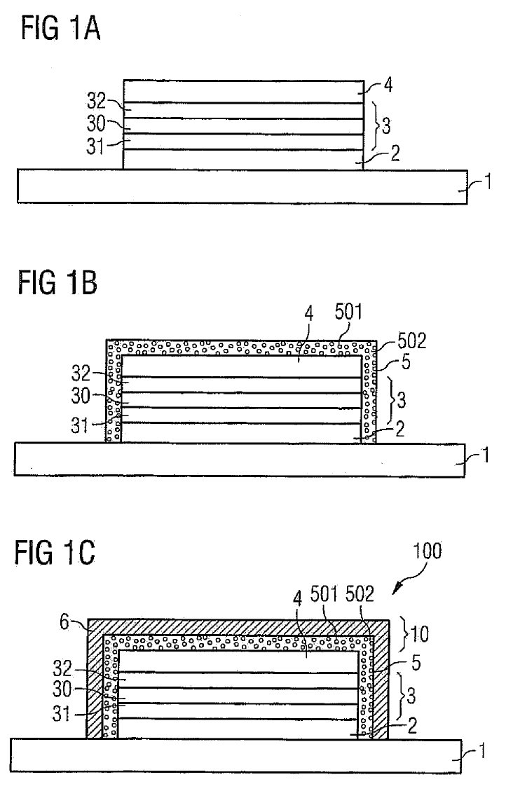

FIGS. 1A to 1C show a method for producing an organic optoelectronic component 100.

In this case, in a first method step A in accordance with FIG. 1A, a substrate 1 is provided, for instance a glass substrate, as an alternative or in addition, the substrate 1 can also comprise or be for example a metal film or plastic film. A first electrode 2 is applied to the substrate 1. A radiation-emitting layer sequence 3 having functional layers 31, 32 and an active region 30 is arranged on the first electrode 2. In the exemplary embodiment shown, the optoelectronic component is embodied as an organic light-emitting diode (OLED). The radiation-emitting layer sequence 3 thus has organic functional layers as described above. A second electrode 4 is arranged on the radiation-emitting layer sequence 3.

The active region 30 is suitable for emitting an electromagnetic primary radiation in a blue wavelength range when an electric current is applied to the first and second electrodes 2, 4. The second electrode 4 comprises a metal or a TCO and is transparent to the primary radiation.

In a further method step B, as shown in FIGS. 1B and 1C, an encapsulation arrangement 10 is applied on the second electrode. In this case, as shown in FIG. 1B, a wavelength conversion layer 5 having a wavelength conversion substance 501 embedded in a matrix material 502 composed of liquid phase is applied in a first substep B1. In this case, the matrix material comprises a transparent plastic, silicone in the exemplary embodiment shown. The wavelength conversion layer 5 is cured by crosslinking of the matrix material 502.

The wavelength conversion substance 501 is suitable for partly absorbing the blue primary radiation and emitting yellow secondary radiation. As a result of the superposition of the primary radiation and the secondary radiation, the optoelectronic component 100 can give an observer a white-colored luminous impression during operation.

In a further substep B2, as shown in FIG. 1C, a barrier layer 6 is applied on the wavelength conversion layer 5. The barrier layer 6 is applied by means of a CVD method and protects the electrodes 2, 4 and the radiation-emitting layer sequence 3 against damage caused by oxygen and/or moisture. The barrier layer 6 comprises aluminum oxide for this purpose. As an alternative or in addition, another material from the materials mentioned above can also be applied. By means of the matrix material 502 of the wavelength conversion layer 5, the wavelength conversion layer 5 simultaneously serves as a planarization layer on the second electrode 4, on which the barrier layer 6 can be applied homogenously and uniformly.

The encapsulation arrangement 10, comprising the layer stack having the wavelength conversion layer 5 and the barrier layer 6, together with the substrate 1 encapsulates the radiation-emitting layer sequence 3 and the electrodes 2, 4.

In the case of the optoelectronic component 100, the advantages of the conversion concept can be utilized, namely avoiding a differential color ageing of the active region 30 and separate optimization of the perceptible color locus and of the electronic properties of the radiation-emitting layer sequence 3. Furthermore, the advantages of the “top emitter” concept can be utilized, namely the possibility of being able to choose the substrate 1 independently of its optical properties, and also good coupling out of radiation from the encapsulation arrangement 10 and an inexpensive encapsulation that is technically simple to produce.

The following figures show further exemplary embodiments representing variations of the exemplary embodiment shown in FIGS. 1A to 1C. Therefore, the description below essentially relates to the differences from the previous exemplary embodiment.

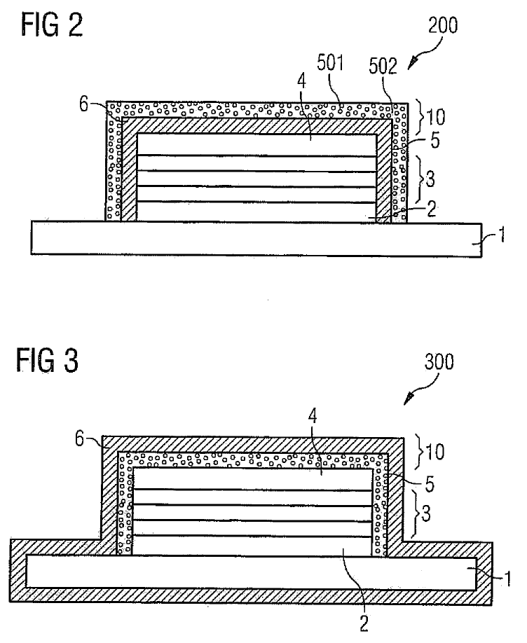

FIG. 2 shows an exemplary embodiment of an optoelectronic component 200. The optoelectronic component 200 has an encapsulation arrangement 10 having a barrier layer 6 on the second electrode 4. On the barrier layer 6, which is applied on the second electrode 4 by means of a first method substep B1′, a wavelength conversion layer 5 is applied by means of a second method substep B2′. The encapsulation arrangement 10 can furthermore have a planarization layer (not shown) between the second electrode 4 and the barrier layer 6.

FIG. 3 shows an exemplary embodiment of an optoelectronic component 300, in which, as in the optoelectronic component 100 in FIGS. 1A to 1C, the encapsulation arrangement 10 has a barrier layer 6 on the wavelength conversion layer 5. The barrier layer 6 additionally envelopes the substrate 1, such that the substrate 1 together with the electrodes 2, 4 and the radiation-emitting layer sequence 3 is encapsulated by the barrier layer 6 and thus by the encapsulation arrangement 10. For this purpose, the encapsulation arrangement 10 can have on the substrate further layers such as, for instance, planarization layers or further barrier layers (not shown).

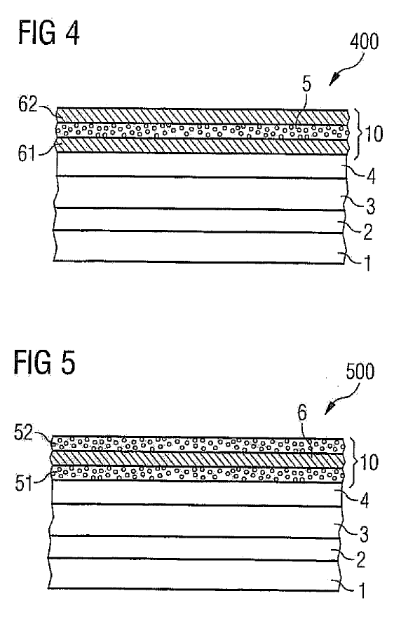

FIGS. 4 to 7 show excerpts from optoelectronic components in accordance with further exemplary embodiments. FIG. 4 shows an optoelectronic component 400 comprising an encapsulation arrangement 10 having a layer stack having a first barrier layer 61 on the second electrode 4. A wavelength conversion layer 5 is applied above said first barrier layer, and a second barrier layer 62 is arranged on said wavelength conversion layer. The first barrier layer 61 and the second barrier layer 62 are thus separated from one another by the wavelength conversion layer 5. What can thereby be achieved is that microchannels which can occur for example in the first barrier layer 61 and which can represent permeation paths for oxygen and/or moisture cannot continue during the subsequent growth of the second barrier layer 62 since the first and second barrier layers 61, 62 are separated from one another by the wavelength conversion layer 5. It is thereby possible to achieve an improvement in the encapsulation effect through a reduction of the permeability of the encapsulation arrangement 10, whereby for example a smaller overall thickness of the barrier layers 61 and 62 may be possible in comparison with the barrier layers 6 of the previous exemplary embodiments.

FIG. 5 shows an exemplary embodiment of an optoelectronic component 500 having an encapsulation arrangement 10 having a first wavelength conversion layer 51 on the second electrode 4. A first barrier layer 6 is applied above said first wavelength conversion layer, and a second wavelength conversion layer 52 is arranged on said first barrier layer. The two wavelength conversion layers 51, 52 can be identical to or different from one another. By means of the encapsulation arrangement 10 in the exemplary embodiment shown, it is possible for example to reduce an angle dependence of the superposed primary radiation and secondary radiation emitted by the optoelectronic component 500 and to increase the coupling-out efficiency.

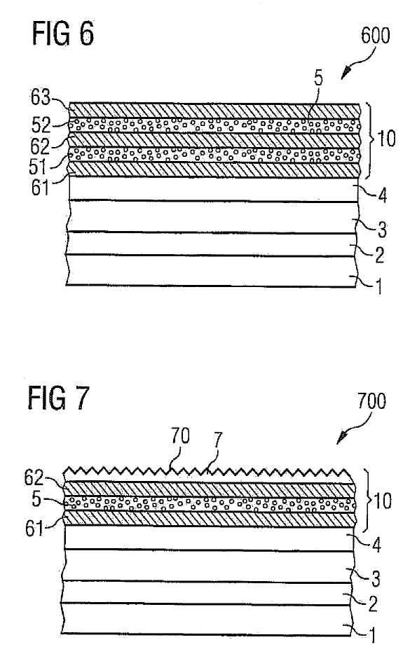

FIG. 6 shows an exemplary embodiment of an optoelectronic component 600 that combines the advantages of the two previous exemplary embodiments. The encapsulation arrangement 10 of the optoelectronic component 600 has a layer stack having a plurality of barrier layers 61, 62, 63 and a plurality of wavelength conversion layers 51, 52, which are arranged alternately one above another. The respective numbers of barrier layers and wavelength conversion layers are purely by way of example and can also deviate from the exemplary embodiment shown. The alternating arrangement of the plurality of barrier layers 61, 62, 63 and wavelength conversion layers 51, 52 makes it possible to effectively avoid the formation of continuous microchannels through the encapsulation arrangement 10. By means of a plurality of barrier layers, it is possible to choose the thickness of the individual barrier layers 61, 62, 63 for example as approximately a quarter of the characteristic wavelength of the primary radiation or the secondary radiation, whereby it is possible to avoid waveguide effects in the barrier layers and thus in the encapsulation arrangement 10. At the same time, the color locus of the luminous impression given by the optoelectronic component can easily be optimized by means of the plurality of wavelength conversion layers 51, 52. As a result, the encapsulation arrangement 10 affords an effective encapsulation effect in conjunction with increased coupling-out efficiency of the emitted electromagnetic radiation.

The optoelectronic component 700 of the exemplary embodiment in FIG. 7 exhibits a surface structure 70 on that surface of the encapsulation arrangement 10 which is remote from the radiation-emitting layer sequence 3, by means of which surface structure the coupling-out efficiency for the emitted electromagnetic radiation can be increased even further. In the exemplary embodiment shown, the surface structure 70 is produced in an outer layer 7 formed by an additional polymer layer. As an alternative to this, such a surface structure 70, which is embodied as microprisms in the exemplary embodiment shown, can also be produced in a barrier layer or a wavelength conversion layer of the previous exemplary embodiments.

The invention is not restricted to the exemplary embodiments by the description on the basis of said exemplary embodiments. Rather, the invention encompasses any new feature and also any combination of features, which in particular comprises any combination of features in the patent claims, even if this feature or this combination itself is not explicitly specified in the patent claims or exemplary embodiments.

We claim:

1. An optoelectronic component comprising:
a substrate;
a first electrode on the substrate;
a radiation-emitting layer sequence having an active region that emits an electromagnetic primary radiation during operation;
on the radiation-emitting layer sequence a second electrode which is transparent to the primary radiation; and
an encapsulation arrangement deposited on the second electrode;
wherein
the encapsulation arrangement has a layer stack having at least one first barrier layer and at least one first wavelength conversion layer that converts the primary radiation at least partly into electromagnetic secondary radiation, and
the encapsulation arrangement is at least partly transparent to the primary radiation and/or to the secondary radiation.

2. The optoelectronic device according to claim 1, wherein the first barrier layer comprises an oxide, a nitride or an oxynitride.

3. The optoelectronic component according to claim 2, wherein the oxide, nitride or oxynitride comprises aluminium, silicon, tin or zinc.

4. The optoelectronic component according to claim 1, wherein the first barrier layer is applicable by a vapor deposition method or a growth method.

5. The optoelectronic component according to claim 1, wherein the first barrier layer is arranged on the second electrode and the first wavelength conversion layer is arranged on the first barrier layer.

6. The optoelectronic component according to claim 1, wherein the first wavelength conversion layer is arranged on the second electrode and the first barrier layer is arranged on the first wavelength conversion layer.

7. The optoelectronic component according to claim 1, wherein
the encapsulation arrangement has a second barrier layer, and
the first wavelength conversion layer is arranged between the first and second barrier layers.

8. The optoelectronic component according to claim 7, wherein microchannels are present in the first to the second barrier layer, and the wavelength conversion layer prevents continuous microchannels between the first and the second barrier layer.

9. The optoelectronic component according to claim 1, wherein the encapsulation arrangement has a plurality of barrier layers and/or a plurality of wavelength conversion layers which are arranged alternately one above another.

10. The optoelectronic component according to claim 1, wherein
the primary radiation has a characteristic first wavelength,
the secondary radiation has a characteristic second wavelength, and
the barrier layer has a thickness of less than or equal to the first and/or the second characteristic wavelength and greater than or equal to 1/10 of the first and/or the second characteristic wavelength.

11. The optoelectronic component according to claim 1, wherein the wavelength conversion layer comprises a wavelength conversion substance in a matrix material and the matrix material comprises at least one from a group formed by polystyrene, polycarbonate, polyacrylic, polymethyl methacrylate, epoxide, polysiloxane, polyurethane and polymers, copolymers and mixtures thereof.

12. The optoelectronic component according to claim 1, wherein the wavelength conversion substance comprises at least one material from a group and the group is formed by garnets of the rare earths and the alkaline earth metals, nitrides, nitridosilicates, siones, sialones, aluminates, oxides, halophosphates, orthosilicates, sulfides, vanadates, chlorosilicates, perylenes, benzopyrenes, coumarins, rhodamines and azo dyes.

13. The optoelectronic component according to claim 1, wherein the encapsulation arrangement has a surface structure on a surface remote from the radiation-emitting layer sequence.

14. The optoelectronic component according to claim 13, wherein the surface structure comprises at least one of roughenings, trenches, prisms, lenses or truncated cones.

15. The optoelectronic component according to claim 13, wherein the encapsulation arrangement has an outer layer, on which the surface structure is present.

16. The optoelectronic component according to claim 1, wherein the encapsulation arrangement has a further layer stack having at least one barrier layer and at least one wavelength conversion layer on a surface of the substrate that is remote from the organic semiconductor layer sequence.

17. A method for producing an optoelectronic component comprising the steps of:
A) providing a substrate with a first electrode, a radiation-emitting layer sequence on the first electrode and a second electrode on the radiation-emitting layer sequence, and
B) applying an encapsulation arrangement having a layer stack comprising at least one first barrier layer and at least one first wavelength conversion layer on the radiation-emitting layer sequence.

18. The method according to claim 17, wherein in step B the at least one first barrier layer is applied by means of a vapor deposition method or a growth method.

19. The method according to claim 17, wherein step B comprises the substeps of:
B1) applying the first barrier layer on the second electrode, and
B2) applying the first wavelength conversion layer on the first barrier layer (6).

20. The method according to claim 17, wherein step B comprises the substeps of:
B1′) applying the wavelength conversion layer on the second electrode, and
B2′) applying the first barrier layer on the wavelength conversion.

21. The method according to claim 19, wherein step B comprises the substep of:
B3) applying a second barrier layer on the first barrier layer and the first wavelength conversion layer.

22. The method according to claim 17, wherein
in step B a plurality of barrier layers and a plurality of wavelength conversion layers are applied alternately.

23. The method according to claim 17, comprising the step of:
C) applying a surface structure to a surface of the encapsulation arrangement that is remote from the radiation-emitting layer sequence.

24. The method according to claim 23, wherein in step C the surface structure is produced by at least one of embossing, etching, roughening or laser removal.
